(19) United States
(12) Patent Application Publication
(10) Pub. No.: US 2025/0144894 A1
(43) Pub. Date: May 8, 2025

(54) METHOD OF MANUFACTURING Y-SHAPED STRINGERS AND DOUBLE Y-SHAPED SPARS MADE OF COMPOSITE MATERIAL

(71) Applicant: AIRBUS OPERATIONS, S.L.U., GETAFE (Madrid) (ES)

(72) Inventors: Alvaro JARA RODELGO, GETAFE (Madrid) (ES); Miguel GONZALEZ ANTOHI, GETAFE (Madrid) (ES); Mikel DE LA PUERTA VALLEJO, GETAFE (Madrid) (ES)

(21) Appl. No.: 18/940,616

(22) Filed: Nov. 7, 2024

(30) Foreign Application Priority Data
Nov. 7, 2023 (EP) 23383136.1

(51) Int. Cl. B29C 70/46; B29L 31/30; B64C 3/18

(52) U.S. Cl. CPC B29C 70/462; B64C 3/185; B29C 2793/009; B29L 2031/3085

(57) ABSTRACT

A method for manufacturing a Y-shaped stringer (100) made of composite material, the Y-shaped stringer (100) includes a stringer web (110) having a cross-section in a I-shape, lower flanges (130a, 130b), a first opened triangular-shaped cross-section structure (120) comprising first and second lower vertices (120a, 120b) respectively joined to the lower flanges (130a, 130b) and an upper vertex (120c) connected to a first end of the stringer web (110), wherein the first opened triangular-shaped cross-section structure (120) and the stringer web (110) form a cross-section in a Y-shape.

### RELATED APPLICATION

This application incorporates by reference and claims priority to European patent application 23383136.1 filed on Nov. 7, 2023.

### TECHNICAL FIELD

The present invention is in the field of manufacturing stringers and spars made of composite material for the aerospace industry and particularly stringers having a Y-shape and spars having a double Y-shape cross-section. The stringers may be applied as stiffeners in an airframe of. The spars may also be used in the airframe, such as in torsion boxes.

### BACKGROUND

CA2619767A1 describes a composite material stringer used to stiffen composite panels, particularly those used in the aeronautical industry. The stringer is formed by a base which is used to join the same to the panel and a structural element which is equipped with a structural reinforcement at the end opposite the base, said structural reinforcement being made from high-modulus unidirectional fibers of the same material as the stringer or of another compatible material.

The existing “double T”-section and the “omega”-section stringers have a limited momentum of inertia, and may suffer from buckling and post-buckling, as well as from torsional behavior. Furthermore, other manufacturing requirements such as weight savings and cost savings are beneficial to improve the existing stringers.

EP3095691A1 relates to a multi-spar torsion box structure comprising a plurality of spars of composite material arranged to form a multi-cell structure with two or more cells extending span-wise one after the other in the torsion box, and upper and lower skin covers of composite material respectively joined to upper and lower surfaces of the multi-cell structure.

The existing “double T”-section and the “omega”-section spars used in multi-spar torsion box structures have a limited momentum of inertia, and may suffer from buckling and post-buckling, as well as from torsional behavior. Furthermore, other manufacturing requirements such as weight savings and cost savings are beneficial to improve the existing spars and torsion boxes.

### SUMMARY

The present invention may be configured satisfies these demands and solves the drawbacks of the current existing stringers used as stiffeners and spars used in multi-spar torsion box structures.

The present invention proposes a first manufacturing method to obtain a composite material stringer (carbon fiber or glass fiber with thermoset or thermoplastic resin) that can be used as stiffener for (preferably composite) panels formed by joining the base or flanges of the stringer and the panel. The proposed stringer comprises a structural cross-section that has a shape in Y. This shape is specified in the present description as a Y-shape and can correspond to the total or a part of the structural cross-section. The proposed stringer is indicated in the present description as a Y-shaped stringer. The Y-shaped stringer according to the present invention comprises two structural elements: an opened triangular-shaped cross-section structure followed by a stringer web that provides a Y-shape. The Y-shaped or Y-section stringer made of composite material has various benefits such as better structural efficiency, less wrinkles when manufacturing due to high angles, no corrosion and better Non-Destructive Testing, NDT process.

The Y-shaped stringer can have various shapes and can comprise vertical fins and a cap with different variations. The use of composite materials for this purpose enhances the actual stringer properties, as well as the inspections and repairability.

The Y-shaped stringer according to the present invention provides an optimization of the “double T”-section and the “omega”-section stringers existing in the art. Advantageously, the proposed Y-shaped stringer increases the momentum of inertia, enhances the buckling and post-buckling behavior, as well as the torsional behavior, and provides a new shape been resulting in the most efficient of the shapes. Furthermore, the Y-section optimizes the disposition of stringers due to the wider effective surface of the feet, which implies weight savings, cost savings and a higher ROI.

Furthermore, the present invention proposes another manufacturing method to obtain a double Y-shaped cross-section spar by connecting two Y-shaped stringers obtained by the first manufacturing method by the stringer webs or by connecting the cap of the Y-shaped stringer to a second cap of a second Y-shaped stringer when the Y-shaped stringers comprise caps.

Furthermore, the present invention proposes a manufacturing method of a torsion box of an aircraft e.g., a wing torsion box comprising the manufactured double Y-shaped cross-section spar. The manufactured torsion box can be used for the vertical tailplane “VTP”, the horizontal tailplane “HTP”, etc.). The proposed torsion box manufacturing method permits the replacement of a conventional spar by the proposed composite material spar, which can be lighter than conventional spars. Furthermore, the number of spars used in a torsion box can be reduced when substituting conventional spars by the double Y-shaped cross-section spar according to the present invention to obtain the same mechanical characteristics.

A first aspect of the present invention refers to a method for manufacturing a Y-shaped stringer made of composite material, the Y-shaped stringer comprises a stringer web having a cross-section in a I-shape, lower flanges a first opened triangular-shaped cross-section structure comprising lower vertices respectively joined to the lower flanges and an upper vertex connected to a first end of the stringer web, wherein the first opened triangular-shaped cross-section structure and the stringer web form a cross-section in a Y-shape, the method comprises placing composite material onto first mold and a second mold that each comprises a molding curvature having an angle β=360°−α, wherein α is a working angle formed in a joint between the first opened triangular-shaped cross-section structure and the lower flanges, wherein α has a value between 100 to 165°, placing composite material onto a third mold, closing the first mold and the second mold with the third mold to obtain a closed mold that contains a Y-shaped preform and curing the Y-shaped preform with an autoclave cycle to obtain the Y-shaped stringer.

In one example, the method further comprises cutting the Y-shaped stringer.

In one example, curing the Y-shaped preform with an autoclave cycle comprises curing the Y-shaped preform at 180 degrees Celsius or less.

In one example, the method further comprises placing a rowing in between the first mold and the second mold.

In one example, the method further comprises obtaining the first mold, the second mold and the third mold with 3D printing. The materials to be used are thermoplastics from the PEI/PEEK/PEKK families due to their good properties at high temperatures and their good resistance.

In one example, the method further comprises establishing the lower flanges in a perpendicular direction to the stringer web with the shape of the first mold, the second mold and the third mold.

In one example, the method further comprises using carbon fiber with thermoset or thermoplastic resin or glass fiber with thermoset or thermoplastic resin as composite material.

In one example, the method further comprises connecting a cap to a second end of the stringer web that provides the stringer web with a cross-section in a T-shape or in a L-shape or in a J-shape.

In one example, the cap comprises a symmetric laminate composed by:
a first layer comprising composite laminates that wrap the lower flanges the stringer web, wherein a 70% of the total composite laminates from the first layer are oriented at a load angle +/−45°, wherein the load angle is the angle of the load with respect to the Y-shaped stringer reference axis;
a second layer comprising composite laminates that can be established on top of the first layer wherein a 70% of the total composite laminates from the first layer are oriented at a load angle 0°.
a third layer comprising composite laminates that can be established on top of the second one, wherein a 70% of the total composite laminates from the third layer are oriented at a load angle +/−45°.

In one example, the method further comprises establishing vertical fins in a parallel direction to the stringer web with the shape of the first mold, the second mold and the third mold.

A second aspect of the present invention refers to the use of the Y-shaped stringer according to the first aspect of the present invention as stiffener for a panel of an aircraft by joining the lower flanges to the panel of the aircraft by cocuring or cobounding.

In a third aspect, the present invention refers to a method for manufacturing a double Y-shaped cross-section spar comprising a spar web, lower spar flanges, upper spar flanges and first cross-section opened triangular-shaped spar structure and a second cross-section opened triangular-shaped spar structure, the method comprising connecting a second end of the stringer web of the Y-shaped stringer to a second stringer web of a second Y-shaped stringer obtained by the method according to claims 1 to 10.

In a fourth aspect, the present invention refers to a method for manufacturing a torsion box for an aircraft comprising a plurality of double Y-shaped cross-section spars obtained by the method according to the previous claim and a first panel and a second panel, the method comprising placing at least the plurality of double Y-shaped cross-section spars in between first molds, wherein the first molds are associated with at least the shape of the spar web, and the lower spar flanges and the upper spar flanges, placing second molds onto the first cross-section opened triangular-shaped spar structure and onto the second cross-section opened triangular-shaped spar structure, placing composite material at least onto the second molds, closing the first molds and the second molds with third molds to obtain a closed mold that contains a torsion box preform, wherein the third molds are associated with at least the shape of the first panel of the torsion box and the shape of the second panel of the torsion box of the aircraft and curing the torsion box preform with an autoclave cycle to obtain the torsion box.

In an example, the method further comprising cutting the torsion box.

In one example, curing the torsion box preform with an autoclave cycle comprises curing the torsion box preform at 180 degrees Celsius or less.

### SUMMARY OF DRAWINGS

For a better understanding of the above explanation and for the sole purpose of providing an example, some non-limiting drawings are included that schematically depict a practical embodiment.

FIG. 1 shows a first example of the Y-shaped stringer obtained by the first manufacturing method according to the present invention.

FIG. 2 shows a second example of the Y-shaped stringer obtained by the first manufacturing method according to the present invention comprising vertical fins.

FIG. 3 shows a third example of the Y-shaped stringer obtained by the first manufacturing method according to the present invention comprising vertical fins and a cap.

FIG. 4 shows example of the double Y-shaped cross-section spar obtained by the second manufacturing method according to the present invention.

FIG. 5 shows molds used in the first manufacturing method to obtain a Y-shaped stringer according to the present invention.

FIG. 6 shows molds used in the third manufacturing method to obtain a torsion box according to the present invention.

FIG. 7 shows the Y-shaped stringer (100) according to the present invention used as a stiffener for a panel (1010) of an aircraft.

FIG. 8 shows a torsion box obtained by the third manufacturing method according to the present invention comprising a plurality of double Y-shaped cross-section spars.

### DETAILED DESCRIPTION

The Y-shaped stringer obtained by the first manufacturing method according to the present invention comprise three different parts: an opened triangular-shaped cross-section structure that enhances the behavior to torsional loads, the flanges connected to the opened triangular-shaped cross-section structure that can be configured to be joined to a panel or skin of the aircraft and a slim part or stringer web established in a normal direction to the flanges that increases the momentum of inertia and the structural stiffness of the Y-shaped stringers according to the present invention.

The double Y-shaped cross-section spar obtained by the manufacturing method according to the present invention comprise two Y-shaped stringers connected by the webs of the stringers.

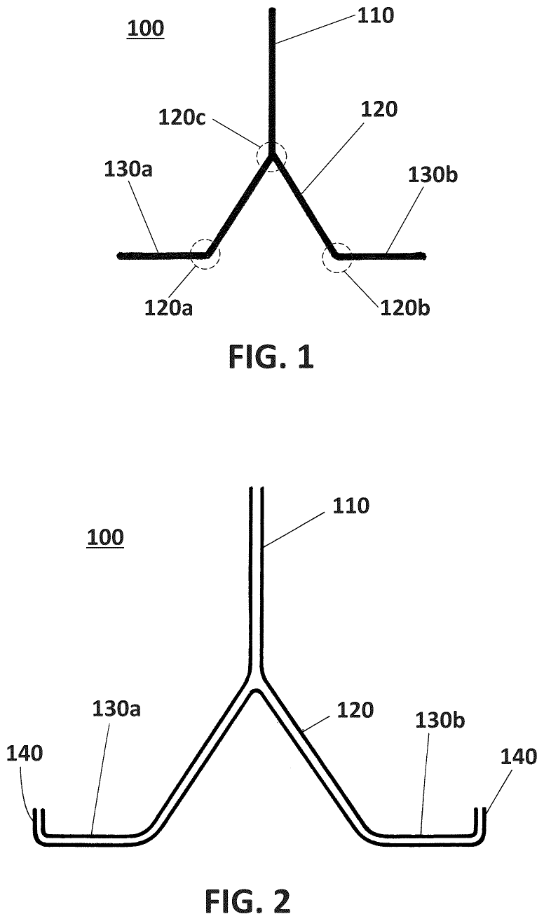

FIG. 1 shows a first example of the Y-shaped stringer (100) according to the present invention. The Y-shaped stringer (100) can be made of composite material and can be used as stiffener for a panel of an aircraft. The panel (1010) can be made of composite. The Y-shaped stringer (100) shown in FIG. 1 comprises a stringer web (110) having cross-section a I-shape, a first opened triangular-shaped cross-section structure (120) that comprises lower vertices (120a, 120b) joined or connected to lower flanges (130a, 130b). In this example, the lower flanges (130a, 130b) are established in a perpendicular or normal direction to the stringer web (110). The lower flanges (130a, 130b) are configured to be connectable to the panel of the aircraft.

Furthermore, the first opened triangular-shaped cross-section structure (120) comprises an upper vertex (120c) connected to the stringer web (110) having a l-shape. As shown in FIG. 1, the first opened triangular-shaped cross-section structure (120) in connection with the stringer web (110) form a Y-shape.

FIG. 2 shows a second example of the Y-shaped stringer (100) according to the present invention. In this example, the Y-shaped stringer (100) comprises vertical fins (140) connected to the lower flanges (130a, 130b) and established in a parallel direction to the stringer web (110). The vertical fins (140) can improve the resistance to buckling and post-buckling and the stiffness of the Y-shaped stringer (100).

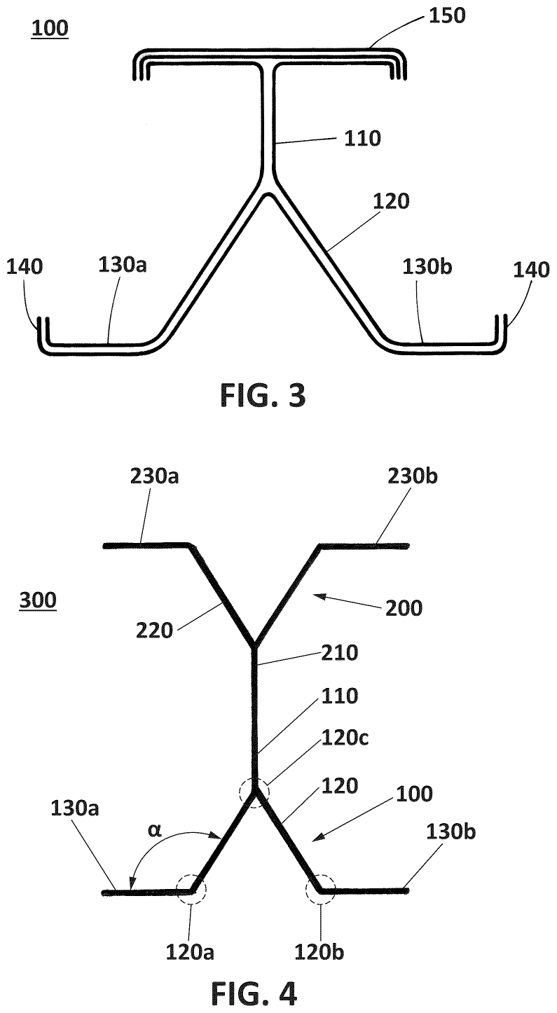

FIG. 3 shows a third example of the Y-shaped stringer (100) according to the present invention. The Y-shaped stringer (100) shown in FIG. 3 comprises all the elements of the example of FIG. 2 and furthermore it comprises a cap (150) that provides the stringer web (110) with a T-shape.

Composite laminates must be oriented to achieve the best possible properties, to avoid buckling and to prevent warping after manufacturing (the laminate must be symmetrical and balanced). The improvement of the laminate properties is related to where the fiber angles are oriented. That is, if the load goes in the direction of 0° according to the Y-shaped stringer reference axis, a greater percentage of laminates will be placed at 0° with respect to the Y-shaped stringer reference axis because that is where the laminates will have the best mechanical properties. The total percentage is divided into laminates at 0°, laminates at 90° and laminates at +/−45°. So, as the different parts of the Y-shaped stringer (100) work differently (lower flanges (130a, 130b), stringer web (110) and the cap (150)), each part has to have a greater amount of laminates in the orientation in which it is of interest for the best mechanical response. An example of a symmetrical and balanced composite laminate may be: +45°, −45°, 0°, 90°, 0°, 0°, 90°, 0°, −45°, +45°, which is also written as (+45, −45, 0, 90, 0) S).

Graphite fiber-reinforced polymer, CFRP's are made of several layers. Each layer is a “cloth,” “ribbon,” or “strip” (like a piece of cloth) of carbon fibers. In this “fabric” the fibers can be disordered, woven or mostly oriented in one direction. In general, those that have a main orientation are used, because in this main direction we know that it has resistance to significant loads. Then, when the layers are stacked, each layer can be oriented as desired to adapt the load resistance of the final piece according to the orientations of each of its layers.

The cap (150) can be divided into three stacked layers:
A first layer comprising composite laminates that wrap the lower flanges (130a, 130b), the stringer web (110) and the cap (150), wherein a 70% of the total composite laminates from the first layer are oriented at a load angle +/−45°, wherein the load angle is the angle of the load with respect to the Y-shaped stringer reference axis;
A second layer comprising composite laminates that can be established on top of the first layer wherein a 70% of the total composite laminates from the first layer are oriented at a load angle 0°.
A third layer comprising composite laminates that can be established on top of the second one, wherein a 70% of the total composite laminates from the third layer are oriented at a load angle +/−45°.

Hence, the first and the third layer can comprise a maximum of composite laminates oriented at +/−45°, wherein +/−45° is the angle of the load with respect to the Y-shaped stringer reference axis and with a 70% of the total composite laminates from the first and the third layer (because it is interesting to have more at +/−45° to avoid local and global buckling and due to design rules and laminate theory).

The second layer would have a maximum of 70% of the total composite laminates of the second layer oriented at 0° wherein 0° is the angle of the load with respect to the Y-shaped stringer reference axis, because it is important that the cap have a core with 0° orientation since that would be the orientation of the main load (which would be perpendicular to the plane of the section).

The third example of the Y-shaped stringer (100) is the most complete Y-shaped stringer section that can improve the behavior of the Y-shaped stringer (100) in the main load direction, enhancing the momentum of inertia and the elastic modulus (E), increasing the stiffness of the stringer, and consequently, of the panel.

FIG. 4 shows a first example of the double Y-shaped cross-section spar (300) obtained by the manufacturing method according to the present invention. The double Y-shaped cross-section spar (300) can be made by joining the Y-shaped stringer (100) to a second Y-shaped stringer (200) that comprises a stringer web (210), and wherein a second end of the stringer web (110) is connected to the second stringer web (210) of the second Y-shaped stringer (200).

The double Y-shaped cross-section spar (300) comprises a spar web that is obtained by connecting the stringer web (110) and the second stringer web (210) having both webs a cross-section in a I-shape.

The double Y-shaped cross-section spar (300) comprises two parts connected by the spar web, i.e., a lower part corresponding to the Y-shaped stringer (100), and an upper part corresponding to the second Y-shaped stringer (200).

The lower part corresponding to the Y-shaped stringer (100) comprises lower flanges (130a, 130b) that can be configured to be connectable to a first panel (1010) of a torsion box of the aircraft (as shown in FIG. 8), the first opened triangular-shaped cross-section structure (120) that comprises first and second lower vertices (120a, 120b) respectively joined to the lower flanges (130a, 130b) and an upper vertex (120c) connected to a first end of the stringer web (110).

The upper part corresponding to the second Y-shaped stringer (200) comprises upper flanges (230a, 230b) configured to be connectable to a second panel (1020) of the torsion box of the aircraft, a second opened triangular-shaped cross-section structure (220) joined to upper flanges (230a, 230b) and to the second stringer web (210).

The first opened triangular-shaped cross-section structure (120), the second opened triangular-shaped cross-section structure (220) and the stringer web (110) and the second stringer web (210) form a cross-section in a double Y-shape.

The double Y-shaped cross-section spar (300) the most suitable example according to the present invention for production as this would still have an optimal structural behavior and could easily be mass-produced with a fast prototyped mold using 3D printing techniques.

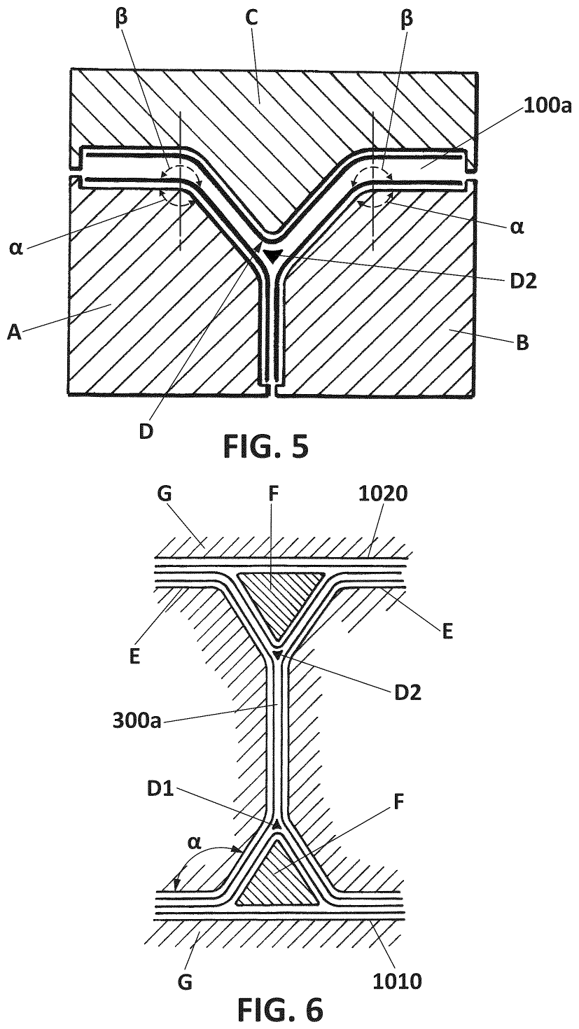

FIG. 5 shows molds used in the manufacturing method of the Y-shaped stringer (100) according to the present invention.

FIG. 5 shows a first mold (A) and a second mold (B) that comprise a molding curvature (X) having an angle β=360°−α, wherein α is a working angle formed in a joint between the first opened triangular-shaped cross-section structure (120) and the lower flanges (130a, 130b) of the Y-shaped stringer (100), wherein α has a value between 100 to 165°.

The angles β and α can be adapted to optimize the load transmission but ensuring that no wrinkles are formed during the manufacturing process of the Y-shaped stringer (100). An optimum working angle can be e.g., 135°.

Furthermore, FIG. 5 shows a third mold (C) that closes the first mold (A) and second mold (B) to obtain a Y-shaped preform (100a). The Y-shaped preform (100a) is composed by laminates and between the laminates a rowing (D2) can be placed to ensure that no voids are created in the joint of the laminates.

The manufacturing process of the Y-shaped stringer (100) can comprise placing composite material onto the first mold (A) and placing composite material onto the second mold (B) that comprise the molding curvature (X) having an angle β=360°−α, and placing composite material onto the third mold (C), and closing the first mold (A) and the second mold (B) with the third mold (C) to obtain a closed mold that contains the Y-shaped preform (100a), and curing the Y-shaped preform (100a) with an autoclave cycle to obtain the Y-shaped stringer (100).

Additionally, the method can comprise cutting the Y-shaped stringer (100).

In one example, the cheapest manufacturing option for a Y-shaped stringer (100) and the most suitable option for production would be the stringer without vertical fins (140) and the stringer web (110) with a I-shape without the cap (150). This Y-shaped stringer (100) can have an optimal structural behavior and could easily be mass-produced with a fast prototyped mold using additive printing techniques such as three dimensional (3D) printing.

In a particular example, the manufacturing of Y-shaped stringer (100) comprises the manufacturing of the first mold (A), the second mold (B) and the third mold (C) with 3D printing, a fiber placement process over the first mold (A) and the second mold (B) of pre impregnated fibre or dry fibre that can be infused with resin, the closing of the first mold (A) and the second mold (B) with the third mold (C) conforming the Y-shaped preform (100a), the use of an autoclave cycle at 180° or lower to optimize the in-service temperature of the Y-shaped stringer (100), and a last additional step of cutting the Y-shaped stringer (100).

FIG. 6 shows molds used in the manufacturing method of a torsion box (2000) (shown in FIG. 8) for an aircraft comprising a plurality of double Y-shaped cross-section spars (300) obtained by the method according to the previous claim and a first panel (1010) and a second panel (1020).

The torsion box (2000) comprises a plurality of double Y-shaped cross-section spar (300) obtained with a manufacturing method according to the present invention. The double Y-shaped cross-section spar (300) comprising a spar web, lower spar flanges, upper spar flanges and a first cross-section opened triangular-shaped spar structure and a second cross-section opened triangular-shaped spar structure.

The manufacturing of the torsion box (2000) can comprise placing a plurality of double Y-shaped cross-section spars (300) in between first molds (E), wherein the first molds (E) are associated with at least the shape of the spar web, and the lower spar flanges and the upper spar flanges.

The manufacturing of the torsion box (2000) can further comprise placing second molds (F) onto the first cross-section opened triangular-shaped spar structure and onto the second cross-section opened triangular-shaped spar structure and placing composite material at least onto the second molds (F). Placing the composite material can comprise a fiber placement process over the molds of pre impregnated fiber or dry fiber that can be later be infused with resin.

The manufacturing of the torsion box (2000) can further comprise closing the first molds (E) and the second molds (F) with third molds (G) to obtain a closed mold that contains a torsion box preform (300a), wherein the third molds (G) are associated with at least the shape of the first panel (1010) of the torsion box and the shape of the second panel (1020) of the torsion box of the aircraft, and curing the torsion box preform with an autoclave cycle.

The method further comprising cutting the torsion box (2000).

In the proposed method, curing the torsion box preform (300a) with an autoclave cycle comprises curing the torsion box preform at 180 degrees Celsius or less.

In one example, α is equal to 135°.

The first molds (E) and the second molds (F) conform the spar web. The second molds (F) and the third molds (G) conform the opened triangular-shaped cross-section spar structures and the first panel (1010) of the torsion box (2000) and the second panel (1020) of the torsion box (2000).

The α is variable that can be adapted to optimize the load transmission, but those that ensure that no wrinkles are formed during the manufacturing.

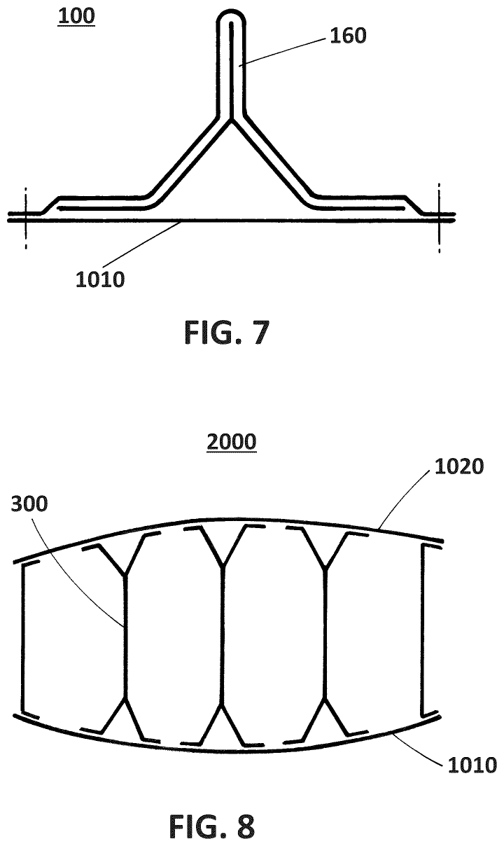

FIG. 7 shows the Y-shaped stringer (100) according to the present invention used as a stiffener for the panel (1010) of an aircraft by joining the lower flanges (130a, 130b) of the Y-shaped stringer (100) to the composite panel (1010) of the aircraft as shown in FIG. 7. The panel (1010) can be a composite panel.

The joining of the lower flanges (130a, 130b) of the Y-shaped stringer (100) to the panel (1010) of the aircraft can comprise in a first alternative cocuring or in a second alternative cobounding.

It is important to notice that this shape still allows the usage of mouseholes (160) without affecting the structural behavior while reducing weight. The mouseholes (160) are holes made in the ribs of the structure of the aircraft to help positioning and assembling the wing's structure. These holes also permit the interconnection of the fuel tanks.

FIG. 8 shows an example torsion box (2000) comprising the double Y-shaped cross-section spars (300) according to the present invention. FIG. 8 shows a possible arrangement of a wing torsion box that shows the first panel (1010) of the torsion box and the second panel (1020) of the torsion box of the aircraft, a front and a rear spar and a plurality of double Y-shaped cross-section spars (300) that will vary depending on the dimensions of the torsion box (2000).

The invention may be embodied as a method for manufacturing a Y-shaped stringer (100) made of composite material, the Y-shaped stringer (100) comprising a stringer web (110) having a cross-section in a I-shape, lower flanges (130a, 130b), a first opened triangular-shaped cross-section structure (120) comprising first and second lower vertices (120a, 120b) respectively joined to the lower flanges (130a, 130b) and an upper vertex (120c) connected to a first end of the stringer web (110), wherein the first opened triangular-shaped cross-section structure (120) and the stringer web (110) form a cross-section in a Y-shape, the method comprising: placing composite material onto first mold (A) and a second mold (B) that each comprises a molding curvature (X) having an angle β=360°−α, wherein α is a working angle formed in a joint between the first opened triangular-shaped cross-section structure (120) and the lower flanges (130a, 130b), wherein α has a value between 100 to 165°; placing composite material onto a third mold (C); closing the first mold (A) and the second mold (B) with the third mold (C) to obtain a closed mold that contains a Y-shaped preform (100a); and curing the Y-shaped preform (100a) with an autoclave cycle to obtain the Y-shaped stringer (100).

The method may include cutting the Y-shaped stringer (100) and curing the Y-shaped preform (100a) with an autoclave cycle comprises curing the Y-shaped preform (100a) at 180 degrees Celsius or less.

The method may include placing a rowing (D1, D2) in between the first mold (A) and the second mold (B).

The method may include forming by three dimensional (3D) printing at least one of the first mold (A), the second mold (B) or the third mold (C).

The method may include establishing the lower flanges (130a, 130b) in a perpendicular direction to the stringer web (110) with the shape of the first mold (A), the second mold (B) and the third mold (C).

The may include using carbon fiber with thermoset or thermoplastic resin or glass fiber with thermoset or thermoplastic resin as composite material.

The method may include establishing vertical fins (140) in a parallel direction to the stringer web (110) with the shape of the first mold (A), the second mold (B) and the third mold (C).

The method may include connecting a cap (150) to a second end of the stringer web (110) that provides the stringer web (110) with a cross-section in a T-shape or in a L-shape or in a J-shape. The cap (150) may comprise: a first layer comprising composite laminates that wrap the lower flanges (130a, 130b), the stringer web (110), wherein a 70% of the total composite laminates from the first layer are oriented at a load angle +/−45°, wherein the load angle is the angle of the load with respect to the Y-shaped stringer reference axis; a second layer comprising composite laminates that can be established on top of the first layer wherein a 70% of the total composite laminates from the first layer are oriented at a load angle 0°, and a third layer comprising composite laminates that can be established on top of the second one, wherein a 70% of the total composite laminates from the third layer are oriented at a load angle +/−45°.

The Y-shaped stringer (100) may be a stiffener for a panel (1010) of an aircraft by joining the lower flanges (130a, 130b) to the panel (1010) of the aircraft by cocuring or cobounding.

The invention may be embodied as a method for manufacturing a double Y-shaped cross-section spar (300) comprising at least a spar web, lower spar flanges, upper spar flanges and a first cross-section opened triangular-shaped spar structure and a second cross-section opened triangular-shaped spar structure, the method comprising: connecting a second end of the stringer web (110) of a Y-shaped stringer (100) to a second end of a second stringer web (210) of a second Y-shaped stringer (200); or connecting the cap (150) of the Y-shaped stringer (100) to a second cap of a second Y-shaped stringer (200).

The invention may be embodied as a method for manufacturing a torsion box (2000) for an aircraft comprising a plurality of double Y-shaped cross-section spars (300), a first panel (1010) and a second panel (1020), the method comprising: placing at least the plurality of double Y-shaped cross-section spars (300) in between first molds (E), wherein the first molds (E) are associated with at least the shape of the spar web, and the lower spar flanges and the upper spar flanges; placing second molds (F) onto the first cross-section opened triangular-shaped spar structure and onto the second cross-section opened triangular-shaped spar structure; placing composite material at least onto the second molds (F); closing the first molds (E) and the second molds (F) with third molds (G) to obtain a closed mold that contains a torsion box preform (300a), wherein the third molds (G) are associated with at least the shape of the first panel (1010) of the torsion box (2000) and the shape of the second panel (1020) of the torsion box (2000) of the aircraft, and curing the torsion box preform (300a) with an autoclave cycle to obtain the torsion box (2000).

The method may further comprise cutting the torsion box (2000 or curing the torsion box preform with an autoclave cycle comprises curing the torsion box preform at 180 degrees Celsius or less.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both, unless the disclosure states otherwise. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for manufacturing a Y-shaped stringer made of composite material, the Y-shaped stringer comprising a stringer web having a cross-section with an I-shape, lower flanges, a first opened triangular-shaped cross-section structure comprising first and second lower vertices respectively joined to the lower flanges, and an upper vertex connected to a first edge of the stringer web, wherein an assembly of the first opened triangular-shaped cross-section structure and the stringer web form in cross section a Y-shape,
the method comprising:
placing composite material on a first mold and on a second mold each comprising a molding curvature having an angle β=360°−α, wherein α is a working angle formed in a joint between the first opened triangular-shaped cross-section structure and the lower flanges, wherein α has a value in a range of 100 degrees to 165 degrees;
placing composite material on a third mold;
closing the first mold and the second mold with the third mold to obtain a closed mold assembly that contains a Y-shaped preform; and
curing the Y-shaped preform in the closed mold assembly with an autoclave cycle to form the Y-shaped stringer.

2. The method according to claim 1, further comprising cutting the Y-shaped stringer.

3. The method according to claim 1, wherein the curing of the Y-shaped preform with the autoclave cycle comprises curing the Y-shaped preform at a temperature of no more than 180 degrees Celsius.

4. The method according to claim 1, further comprising placing a rowing between the first mold and the second mold.

5. The method according to claim 1, further comprising forming the first mold, the second mold and the third mold by an additive printing process.

6. The method according to claim 1, further comprising aligning the lower flanges in a direction perpendicular to the stringer web.

7. The method according to claim 1, further comprising using carbon fiber with at least one of a thermoset resin, a thermoplastic resin or glass fiber with thermoset or thermoplastic resin as the composite material.

8. The method according to claim 1, further comprising forming a vertical fin extending in a direction parallel to the stringer web, wherein the method includes integrating the stringer web within the vertical fin.

9. The method according to claim 1, further comprising connecting a cap to a second end of the stringer web, wherein the cap and the stringer web form an assembly which in cross-section is T-shaped, L-shape or J-shaped.

10. The method according to claim 9, wherein the cap comprises:
a first layer comprising composite laminates that overlap the lower flanges and the stringer web, wherein 70% of the composite laminates of the first layer are oriented at a load angle of +/−45°, wherein the load angle is an angle of a load with respect to a Y-shaped stringer reference axis;
a second layer comprising composite laminates on the first layer, wherein 70% of the composite laminates from the second layer are oriented at a load angle of 0°, and
a third layer comprising composite laminates on a surface of the second layer opposite to the first layer, wherein a 70% of the composite laminates of the third layer are oriented at a load angle of +/−45°.

11. The method of claim 1, further comprising joining the Y-shaped stringer to a panel of an aircraft by joining the lower flanges to the panel of the aircraft by co-curing or co-bounding the Y-shaped stringer to the panel.

12. A method of claim 1, configured to manufacture a double Y-shaped cross-section spar comprising at least a spar web, lower spar flanges, upper spar flanges and a first cross-section opened triangular-shaped spar structure and a second cross-section opened triangular-shaped spar structure,
the method comprising:
connecting a second end of the stringer web of the Y-shaped stringer to a second end of a second stringer web of a second Y-shaped stringer, or
connecting a first cap at a distal edge of the spar web of the Y-shaped stringer to a second cap at a distal edge of a second spar web of a second Y-shaped stringer.

13. The method of claim 12, wherein the method is configured to manufacture a torsion box for an aircraft comprising a plurality of the double Y-shaped cross-section spars, a first panel and a second panel, the method comprising:
placing at least the plurality of double Y-shaped cross-section spars between first molds, wherein the first molds include surface conforming a shape of the spar web, the lower spar flanges and the upper spar flanges;
placing second molds on the first cross-section opened triangular-shaped spar structure and on the second cross-section opened triangular-shaped spar structure;
placing composite material at least on the second molds;
closing the first molds and the second molds with third molds to form a closed mold assembly containing a torsion box preform, wherein the third molds include surfaces conforming to the first panel and second panel of the torsion box of the aircraft, and
curing the torsion box preform with an autoclave cycle to form the torsion box.

14. The method according to claim 13, further comprising cutting the torsion box.

15. The method according to claim 13, wherein the curing of the torsion box preform with an autoclave cycle comprises curing the torsion box preform at a temperature of no greater than 180 degrees Celsius.
